(19) United States
(12) Patent Application Publication
(10) Pub. No.: US 2024/0059609 A1
(43) Pub. Date: Feb. 22, 2024

(54) OIL-TREATED PLASTIC FOR CONCRETE

(71) Applicants: Marvin Burton, Glendale, AZ (US); Christian Hoover, Chandler, AZ (US); Elham Fini, Phoenix, AZ (US)

(72) Inventors: Marvin Burton, Glendale, AZ (US); Christian Hoover, Chandler, AZ (US); Elham Fini, Phoenix, AZ (US)

(21) Appl. No.: 18/496,614

(22) Filed: Oct. 27, 2023

Related U.S. Application Data
(63) Continuation of application No. 17/484,834, filed on Sep. 24, 2021, now Pat. No. 11,827,564.
(60) Provisional application No. 63/082,745, filed on Sep. 24, 2020.

(51) Int. Cl. C04B 18/30; B09B 3/21; B09B 3/40

(52) U.S. Cl. CPC C04B 18/30; B09B 3/21; B09B 3/40; Y02W 30/91; C04B 28/02

(57) ABSTRACT

Treating plastic particles for use in concrete includes combining plastic particles with oil to yield a mixture, heating the mixture to yield a heated mixture, cooling the heated mixture to yield a cooled mixture, and removing excess oil from the cooled mixture to yield oil-treated plastic particles (e.g., oil-treated plastic particles for concrete). In one example, the oil is vegetable oil. The vegetable oil can be soybean oil, corn oil, canola oil, safflower oil, peanut oil, olive oil, grape seed oil, cocoa butter, palm oil, rice bran oil, or a combination thereof. The oil can be waste oil (e.g., waste vegetable oil, such as that recovered from restaurants). The plastic particles can be derived from post-consumer plastic, such as recycled plastic. In one example, the post-consumer plastic includes mixed plastics. A concrete composition can include rocks, sand, cement, and the oil-treated plastic particles.

### CROSS-REFERENCE TO RELATED APPLICATIONS

This application is a continuation of U.S. patent application Ser. No. 17/484,834, filed on Sep. 24, 2021, which claims the benefit of U.S. Patent Application No. 63/082,745, filed on Sep. 24, 2020, which are incorporated herein by reference in their entirety.

### STATEMENT OF GOVERNMENT INTEREST

This invention was made with government support under 1928795 awarded by the National Science Foundation. The government has certain rights in the invention.

### TECHNICAL FIELD

This invention relates to methods for oil-treating plastics for applications in concrete as well as oil-treated plastic and concrete compositions.

### BACKGROUND

Concrete is made of sand, rocks, water, and cement. Concrete has many uses, but its production has a large environmental cost. Cement is the ingredient that binds the sand and rock together and is made by crushing and burning limestone. This process has a high CO 2 footprint. To cope with the demand generated by rising populations, the annual amount of cement produced is only expected to increase. Concrete can withstand very high compressive loads but its ability to resist tension and bending is low. While concrete is often reinforced with steel bars, the rising costs of steel makes this approach expensive.

Small volume fractions and diameters of plastic particles (PP) have been used to fill pores in concrete. However, simply adding PP to concrete can have adverse effects that result in reduced mechanical performance. Particles (single or agglomerates) that cannot adhere to each other or the hydrating cement effectively increase the porosity in concrete, thereby decreasing the density of the concrete and acting as imperfections that amplify stresses. As such, any mechanical property that depends on average applied stresses, density or low porosity can be adversely affected, such as the compressive and tensile strength, Young's modulus, durability, and crack resistance. Typically, the crack resistance and durability of cementitious materials depends at least in part on their ability to absorb energy. Crack resistance can be quantified by determining the fracture energy (G_{f}). When comparing one material to another, a higher G_{f} is an indication that the material can absorb more energy and is more resistant to cracking. However, the porosity of concrete reduces the crack resistance and durability.

### SUMMARY

This disclosure relates to methods for oil-treating plastics for applications in concrete as well as oil-treated plastic and concrete compositions. Oil-treated plastic for concrete (OTPC), typically includes a mixture of plastics coated with oil.

In a first general aspect, treating plastic particles includes combining the plastic particles with oil to yield a mixture, heating the mixture to yield a heated mixture, cooling the heated mixture to yield a cooled mixture, and removing excess oil from the cooled mixture to yield oil-treated plastic particles.

Implementations of the first general aspect can include one or more of the following features.

The mixture can be allowed to remain at ambient temperature for a length of time (e.g., at least 1 hour or at least 10 hours) before heating. Heating the mixture can include radiating the mixture with microwave radiation.

In some cases, the heated mixture is a first heated mixture, and the method further includes heating the cooled mixture to yield a second heated mixture. When the heated mixture is a first heated mixture, the cooled mixture can be a first cooled mixture, and the method can further include cooling the second heated mixture to yield a second cooled mixture. When the heated mixture is a first heated mixture and the cooled mixture is a first cooled mixture, removing the excess oil from the cooled mixture includes removing the excess oil from the second cooled mixture.

Removing the excess oil from the cooled mixture can include draining the excess oil from the cooled mixture to yield the oil-coated plastic particles. Drying the oil-coated plastic particles can include heating the oil-coated plastic particles.

In a second general aspect, an oil treated plastic composition includes plastic particles and oil. The oil forms a coating on the plastic particles.

In a third general aspect, a concrete composition includes rocks, sand, cement, and an oil-treated plastic composition. The oil-treated plastic composition includes plastic particles coated with oil.

Implementations of the first through third general aspects can include one or more of the following features.

In some cases, the oil is vegetable oil. The vegetable oil can be soybean oil, corn oil, canola oil, safflower oil, peanut oil, olive oil, grape seed oil, cocoa butter, palm oil, rice bran oil, or a combination thereof. The oil can be waste oil (e.g., waste vegetable oil, such as that recovered from restaurants). In certain cases, the plastic particles are derived from post-consumer plastic, such as recycled plastic. In one example, the post-consumer plastic includes mixed plastics. The plastic particles can be prepared by grinding and sieving plastic pellets. The plastic particles typically have a dimension in a range of 1 micron to 100 microns or 30 microns to 50 microns.

The OTPC has various advantages. For example, the OTPC binds with calcium-silicate hydroxide in cement, thereby contributing to concrete load bearing. OTPC also retains moisture in the concrete, thereby improving internal curing. OTPC can be used as a partial replacement for cement, sand, fine aggregates, or a combination thereof in concrete to enhance the tensile strength, ductility, and durability, reduce shrinkage and cracking in the concrete, and reduce the ingress of corrosive chemicals and water. This replacement (e.g., 4-20 wt % of cement in the concrete) reduces the weight of the modified concrete and also reduces costs as well the carbon footprint of carbon construction. OTPC can be incorporated into concrete production processes without disruption to the plant and without on-site and labor intensive installation.

The details of one or more embodiments of the subject matter of this disclosure are set forth in the accompanying drawings and the description. Other features, aspects, and advantages of the subject matter will become apparent from the description, the drawings, and the claims.

### DETAILED DESCRIPTION

This disclosure relates to methods for oil-treating plastics for applications in concrete as well as oil-treated plastic and concrete compositions. Oil-treated plastic for concrete (OTPC) typically includes a mixture of plastic particles coated with oil. OTPC is prepared by combining plastic particles with oil to yield a mixture. In some cases, the oil is vegetable oil. The vegetable oil can be soybean oil, corn oil, canola oil, safflower oil, peanut oil, olive oil, grape seed oil, cocoa butter, palm oil, rice bran oil, or a combination thereof. The oil can be waste oil (e.g., waste vegetable oil, such as that recovered from restaurants). In certain cases, the plastic particles are derived from post-consumer plastic, such as recycled plastic. In one example, the post-consumer plastic includes mixed plastics.

Before combining the plastic particles with the oil, the plastic particles can be prepared by reducing the size of plastic pellets or granules. In one example, reducing the size of plastic pellets or granules is achieved by grinding the plastic pellets or granules. A size of the plastic particles is typically in a range of 1 micron to 100 microns (e.g., 10 microns to 90 microns, 20 microns to 70 microns, or 30 microns to 50 microns).

The mixture can include a weight ratio of plastic particles to oil of 10:1 to 1:10. In one example, a weight ratio of plastic particles to oil is about 1:1. The mixture can be allowed to rest at ambient temperature for a length of time (e.g., at least 1 hour or at least 10 hours). As used herein, “ambient” generally refers to the air temperature of the immediate surroundings where the OTPC is prepared. The immediate surroundings can be indoors or outdoors (e.g., 15° C. to 40° C.). The mixture is heated (e.g., to a temperature in a range of 35° C. to 100° C., or 50° C. to 80° C.) to yield a heated mixture. The mixture can be heated in a variety of methods. In one example, the mixture is heated with microwave radiation. The heated mixture is cooled to yield a cooled mixture. In certain cases, the cooled mixture is reheated. The cooled mixture can be heated in a variety of methods. In one example, the cooled mixture is reheated with microwave radiation. The cooled mixture can be allowed to cool again.

Excess oil is removed from the cooled mixture to yield oil-coated plastic particles. Removing the excess oil can be achieved by draining the oil or any other method suitable for separating the plastic particles from excess oil. The oil-coated plastic particles are dried to yield oil-treated plastic particles. Drying the oil-coated plastic particles typically includes heating the oil-coated plastic particles (e.g., in an oven). The oil-coated plastic particles can be heated to yield the oil-treated plastic particles.

OTPC includes plastic particles and oil as described herein. The oil forms a coating on the plastic particles.

A concrete composition modified with OTPC typically includes rocks, sand, cement, and OTPC as described herein. The OTPC can be used replace at least some of the concrete or some of the sand in a conventional concrete composition.

### Example

Plastic granules were prepared by grinding and sieving plastic particles. Particles with a maximum dimension in a range of 30-50 microns were separated and combined in a 1:1 mass ratio with waste soybean oil and mixed thoroughly. This preconditioned mixture was allowed to sit at room temperature for 12 hours, and then irradiated for 4 minutes with microwave radiation. The heated mixture was stirred to ensure proper heat distribution, then allowed to cool for 4 minutes. The cooled mixture was then irradiated with microwave radiation for an additional 4 minutes, stirred to ensure proper heat distribution, and allowed to cool for 20 minutes. After cooling, excess oil was drained, and samples were dried in an oven for 15 minutes at 200° F. The dried samples were used as a partial replacement for cement in a concrete composition.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1.-20. (canceled)

21. A method of forming concrete containing oil-treated plastic particles, the method comprising:
combining plastic particles with oil to yield a mixture;
heating the mixture to yield a heated mixture;
cooling the heated mixture to yield a cooled mixture;
removing excess oil from the cooled mixture to yield oil-treated plastic particles;
adding the oil-treated plastic particles to rocks, sand, and cement; and
binding the oil-treated plastic particles to calcium-silicate hydroxide in the cement.

22. The method of claim 21, wherein the plastic particles are formed by grinding and sieving plastic pellets.

23. The method of claim 21, wherein the plastic particles have a dimension in a range of 1 micron to 100 microns.

24. The method of claim 23, wherein the plastic particles have a dimension in a range of 30 microns to 50 microns.

25. The method of claim 21, wherein the mixture is allowed to remain at ambient temperature for a length of time before heating the mixture.

26. The method of claim 25, wherein the mixture is allowed to remain at ambient temperature for at least 10 hours before heating the mixture.

27. The method of claim 21, wherein heating the mixture comprises radiating the mixture with microwave radiation.

28. The method of claim 21, wherein the heated mixture is a first heated mixture, and further comprising heating the cooled mixture to yield a second heated mixture.

29. The method of claim 28, wherein the cooled mixture is a first cooled mixture, and further comprising cooling the second heated mixture to yield a second cooled mixture.

30. The method of claim 29, wherein removing the excess oil from the cooled mixture comprises removing the excess oil from the second cooled mixture.

31. The method of claim 21, wherein removing excess oil from the cooled mixture comprises draining the excess oil from the cooled mixture to yield the oil-coated plastic particles.

32. The method of claim 31, further comprising drying the oil-coated plastic particles to yield the oil-treated plastic particles.

33. The method of claim 32, wherein drying the oil-coated plastic particles comprises heating the oil-coated plastic particles.

34. The method of claim 21, wherein the plastic particles are derived from post-consumer plastic.

35. The method of claim 34, wherein the post-consumer plastic comprises mixed plastics.

36. The method of claim 21, wherein the oil comprises vegetable oil.

37. The method of claim 36, wherein the vegetable oil comprises waste vegetable oil.

38. The method of claim 36, wherein the vegetable oil comprises soybean oil, corn oil, canola oil, safflower oil, peanut oil, olive oil, grape seed oil, cocoa butter, palm oil, rice bran oil, or a combination thereof.

39. The method of claim 21, wherein the oil-treated plastic particles make up about 4-20 wt % of the cement in the concrete.
